(19) United States
(12) Patent Application Publication
(10) Pub. No.: US 2026/0353001 A1
(43) Pub. Date: Nov. 5, 2026

(54) SELECTIVE BEAMFORMING MUTING FOR AN AUDIO ENVIRONMENT

(71) Applicant: SHURE ACQUISITION HOLDINGS, INC., Niles, IL (US)

(72) Inventors: Bijal Joshi, Niles, IL (US); Doug Daube, Niles, IL (US)

(21) Appl. No.: 19/663,757

(22) Filed: Apr. 30, 2026

Related U.S. Application Data
(60) Provisional application No. 63/797,351, filed on Apr. 30, 2025.

(51) Int. Cl. H04R 3/00; G06F 3/01; G06F 3/16; G06V 20/40; G06V 40/20; G10L 15/22; H04R 1/40

(52) U.S. Cl. CPC H04R 3/005; G06F 3/017; G06F 3/165; G06V 20/41; G06V 40/20; G10L 15/22; H04R 1/406; G10L 2015/223; H04R 2430/01

(57) ABSTRACT

Techniques are disclosed herein for providing selective beamforming muting for an audio environment. Examples may include receiving an audio stream captured by one or more audio capture devices associated with a coverage area of an audio environment, generating sound reinforcement audio by applying signal processing to the audio stream, outputting the sound reinforcement audio via one or more audio output devices associated with a reinforcement area of the audio environment, receiving a muting instruction signal associated with a coverage area identifier corresponding to the coverage area of the audio environment, and disabling a sound reinforcement audio channel between the coverage area and the reinforcement area based on the coverage area identifier to discontinue the output of the sound reinforcement audio via the one or more audio output devices.

### CROSS REFERENCE TO RELATED APPLICATIONS

This application claims the benefit of U.S. Provisional Patent Application No. 63/797,351, titled “SELECTIVE BEAMFORMING MUTING FOR AN AUDIO ENVIRONMENT,” and filed on Apr. 30, 2025, the entirety of which is hereby incorporated by reference.

### TECHNICAL FIELD

Embodiments of the present disclosure relate generally to audio processing and, more particularly, to systems configured to provide beamforming for a microphone array.

### BACKGROUND

A microphone system may utilize two or more microphones to capture audio from an audio environment. Applicant has identified a number of deficiencies for capturing audio via an audio environment.

### BRIEF SUMMARY

Various embodiments of the present disclosure are directed to apparatuses, systems, methods, and computer readable media for providing selective beamforming muting for an audio environment. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example beamforming audio processing system configured to execute sound reinforcement operations and beamforming muting operations in accordance with one or more embodiments disclosed herein;

FIG. 2 illustrates an example beamforming audio processing apparatus configured in accordance with one or more embodiments disclosed herein;

FIG. 3A illustrates an example audio environment associated with sound reinforcement enabled by the beamforming audio processing system in accordance with one or more embodiments disclosed herein;

FIG. 3B further illustrates the example audio environment associated with selective beamforming muting enabled by the beamforming audio processing system in accordance with one or more embodiments disclosed herein;

FIG. 4 illustrates an example audio environment associated with sound reinforcement and selecting selective beamforming muting enabled by the beamforming audio processing system in accordance with one or more embodiments disclosed herein;

FIG. 5 illustrates an example system associated with generation of the muting instructions signal utilized by the beamforming audio processing system in accordance with one or more embodiments disclosed herein;

FIG. 6 illustrates an example system associated with generation of the muting instructions signal utilized by the beamforming audio processing system via speech recognition in accordance with one or more embodiments disclosed herein;

FIG. 7 illustrates an example system associated with generation of the muting instructions signal utilized by the beamforming audio processing system via gesture recognition in accordance with one or more embodiments disclosed herein;

FIG. 8 illustrates an example system associated with a microphone array in accordance with one or more embodiments disclosed herein;

FIG. 9 illustrates another example method for providing selective beamforming muting for an audio environment in accordance with one or more embodiments disclosed herein; and

FIG. 10 illustrates another example method for providing selective beamforming muting for an audio environment in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio system for capturing audio within an audio environment may contain a microphone array, a beamforming module, and/or other digital signal processing (DSP) elements. For example, a beamforming module may be configured to combine microphone signals captured by a microphone array using one or more DSP processing techniques.

A microphone array may utilize two or more microphones to capture audio from an audio environment. Additionally, respective microphones of a microphone array may be located at fixed positions within an audio environment and may employ beamforming to capture audio from one or more sources of audio. For instance, a microphone array may consist of two or more microphones positioned in a predefined geometric configuration such as a linear, circular, or planar geometric configuration. A microphone array may also include beamforming lobes generated via signal processing that are applied to output of the two or more microphones. The beamforming lobes may be directed to capture audio at fixed locations within an audio environment. For example, a beamforming lobe may be configured to focus sensitivity of audio capture for the microphone array in a particular direction by adjusting phase, amplitude, and/or other audio characteristics of signals from individual microphones.

Though microphone arrays have become increasingly prevalent for audio processing related to audio environments, traditional microphone array systems that utilize beamforming are typically incapable of intelligently removing audio associated with a subset of audio sources within an audio environment. For example, undesirable audio from an audio source out of direct beamforming coverage is typically still captured by a microphone array. In certain audio environment scenarios such as courtroom or classroom audio environments, it may be desirable to temporarily exclude certain audio sources or audio environment areas from audio capture without completely disabling functionality of all beamforming lobes of a microphone array.

However, traditional beamforming techniques are typically incapable of intelligently removing audio associated with a subset of audio sources within an audio environment. For example, undesirable audio from an audio source out of direct beamforming coverage may still be captured by a microphone array even though a particular beamforming lobe is dynamically re-directed away from the audio source. Accordingly, less desirable audio systems that utilize a microphone array may be incapable of selectively processing and/or muting audio data for particular audio sources in an audio environment, resulting in inefficiencies and/or inaccuracies with respect to beamforming for the microphone arrays. As such, it is desirable to improve beamforming for microphone arrays in an audio environment.

To address these and/or other technical problems associated with traditional audio systems that utilize a microphone array, various embodiments disclosed herein provide selective (e.g., more localized or more granular) beamforming muting for an audio environment. The selective beamforming muting may provide intelligent muting of an audio source associated with a localized area within an audio environment, thereby enabling optimal privacy with respect to one or more other areas within the audio environment such as a far-end area of the audio environment or a virtual platform associated with the audio environment. For instance, the far-end area may correspond to a different area or a different zone of the audio environment as compared to a capture area or a capture zone for capturing audio within the audio environment. Alternatively, the far-end area may correspond to a non-local side (e.g., a remote side) of an audio conference call or a video conference call as compared to a local capture of audio within the audio environment.

Another technical problem solved by various embodiments is the unintended capture of audio from areas outside of direct beamforming coverage. The system's ability to dynamically configure and selectively mute individual beamforming lobes allows for improved privacy and filtering of undesirable audio sources. This is particularly beneficial in courtrooms or classrooms scenarios mentioned above where temporary exclusion of certain audio sources is necessary without disrupting the overall audio capture and reinforcement.

Various system embodiments also address the challenge of real-time audio source tracking and muting in dynamic environments. By utilizing advanced signal processing techniques, speech recognition, and/or gesture recognition, various system embodiments may intelligently identify audio sources associated with undesirable audio within an audio environment. This enables seamless and accurate muting of specific speakers, audio sources, or coverage areas within an audio environment, even as positions of speakers and/or audio sources change within the audio environment.

Another technical problem overcome by the present disclosure is the need for flexible and customizable muting control in various audio setups. The system's ability to generate muting instruction signals through multiple interfaces - including physical buttons, graphical user interfaces, voice commands, and gestures - provides unprecedented adaptability for different use cases and user preferences. This flexibility allows for more efficient deployment and operation of beamforming microphone arrays in diverse audio environments.

The present disclosure also solves the challenge of maintaining audio quality and intelligibility while selectively muting certain audio sources. By applying sophisticated signal processing techniques to generate and/or selectively mute the sound reinforcement audio, the system ensures that the remaining active audio sources are clearly captured and reproduced, even when portions of the audio environment are muted. This maintains the overall integrity of the audio experience for listeners in the reinforcement area.

### Exemplary Beamforming Audio Processing Systems and Methods

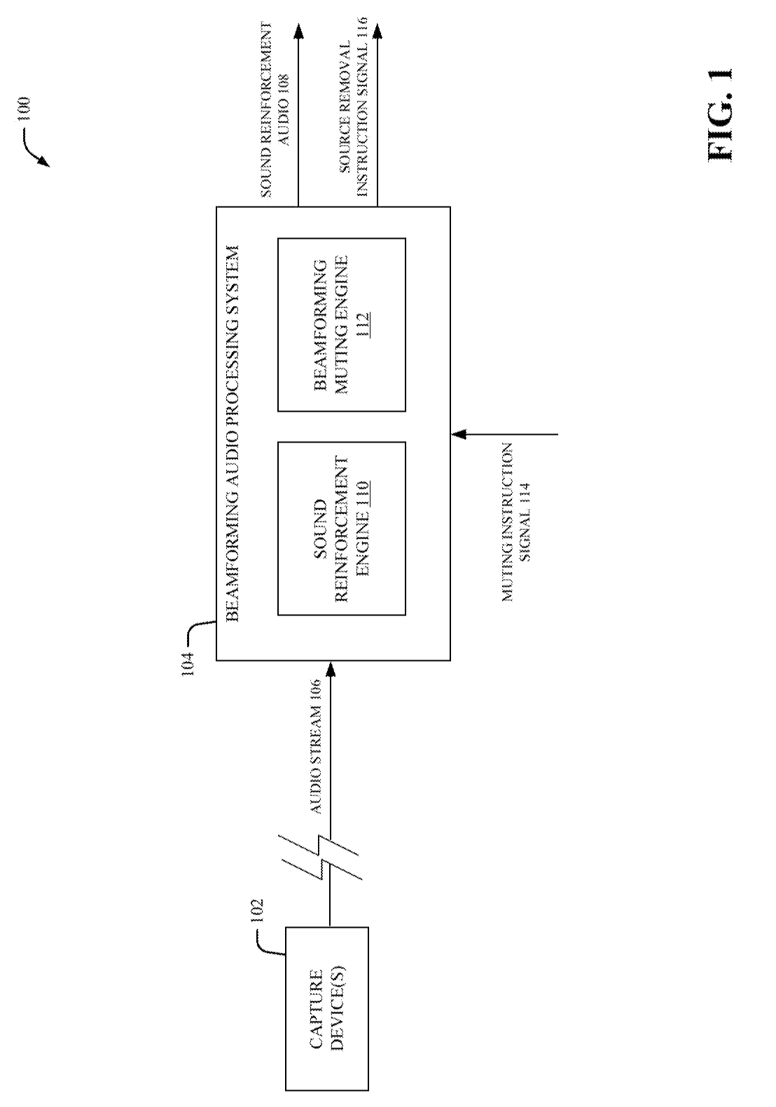

FIG. 1 illustrates an audio signal processing system 100 that is configured to provide selective beamforming muting for an audio environment, according to embodiments of the present disclosure. The audio signal processing system 100 may be, for example, a conferencing system (e.g., a conference audio system, a video conferencing system, a digital conference system, etc.), a classroom microphone system, a lecture hall microphone system, a courtroom microphone system, an audio performance system, an audio recording system, a music performance system, a music recording system, a digital audio workstation, a broadcasting microphone system, an augmented reality system, a virtual reality system, an online gaming system, or another type of audio system.

Additionally, the audio signal processing system 100 may be implemented as an audio signal processing apparatus and/or as software that is configured for execution on a digital conference system, an audio conferencing processor, a wireless conference unit, an audio workstation device, a laptop, a personal computer, a smartphone, an augmented reality device, a virtual reality device, a recording device, headphones, earphones, speakers, or another device. The audio signal processing system 100 disclosed herein may additionally or alternatively be integrated into a virtual DSP processing system (e.g., DSP processing via virtual processors or virtual machines) with other conference DSP processing.

The audio signal processing system 100 may utilize the selective beamforming muting to provide various improvements related to beamforming such as, for example, to: dynamically configure individual beamforming lobes of a microphone array associated with an audio environment, enable muting of individual beamforming lobes of a microphone array associated with an audio environment, intelligently configure individual beamforming lobes of a microphone array (e.g., based on user selection, speech recognition, and/or gesture recognition associated with a sound source), enable optimal privacy and/or filtering for undesirable audio associated with a microphone array, provide real time selection of individual beamforming lobes of a microphone array based on a sound source selection for an audio environment, dynamically configure individual beamforming lobes of a microphone array based on a tracked location of a sound source within an audio environment, improve beamforming accuracy associated with a microphone array, improve efficiency of deploying a microphone array in an audio environment, improve selection of a beamforming scheme for optimal beamforming related to a microphone array associated with an audio environment, and/or improve one or more other beamforming processes related to a microphone array.

As disclosed herein, an audio environment may be an indoor environment, an outdoor environment, a room (e.g., a classroom, a courtroom, or another room in an indoor environment), a lecture hall, a performance hall, a broadcasting environment, a sports stadium or arena, a virtual environment, or another type of audio environment. In various examples, the audio signal processing system 100 may be configured to remove or suppress undesirable sound from one or more beamforming lobes of a microphone array via digital signal processing. In some examples, the audio signal processing system 100 may be additionally or alternatively configured to remove or suppress undesirable sound from one or more beamforming lobes of a microphone array via machine learning and/or by utilizing one or more trained machine learning models. The audio signal processing system 100 may also be employed for another type of audio processing application such as, but not limited to, active noise cancelation, adaptive noise cancelation, etc.

The audio signal processing system 100 includes one or more capture devices 102. The one or more capture devices 102 may respectively be audio capture devices configured to capture audio from one or more sound sources. The one or more capture devices 102 may include one or more sensors configured for capturing audio by converting sound into one or more electrical signals. The audio captured by the one or more capture devices 102 may also be converted into an audio stream 106. The audio stream 106 may comprise digital audio data or, alternatively, analog audio data, related to the one or more electrical signals. The audio stream 106 may also be an audio portion of a video stream captured by the one or more capture devices 102.

In an example, the one or more capture devices 102 are one or more microphones arrays. For example, the one or more capture devices 102 may correspond to a microphone array, one or more microphones of a microphone array, one or more linear microphones of a microphone array, one or more ceiling microphone arrays, one or more table microphone arrays, or another type of microphone arrays. In some examples, the one or more capture devices 102 generate and/or utilize one or more beamformed lobes to enable capture of audio.

In alternate examples, the one or more capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more capture devices 102 may additionally or alternatively include one or more video capture devices, one or more infrared capture devices, one or more sensor devices, and/or one or more other types of audio capture devices.

The one or more capture devices 102 may be positioned within a particular audio environment or proximate to a particular audio environment. In some examples, the one or more capture devices 102 may be associated with a coverage area of an audio environment. For example, the one or more capture devices 102 may be located within the coverage area or proximate to the coverage area to enable capture of at least a portion of the audio stream 106 via the coverage area. In some examples, the audio stream 106 includes audio captured from two or more coverage areas within an audio environment. For instance, the audio stream 106 may include mixed audio associated with two or more coverage areas. A coverage area may be an area within an audio environment that is associated with one or more audio sources.

In some examples, an audio source may be associated with a speaker entity within a coverage area. The speaker entity may refer to a person or other audio-producing source within a coverage area of an audio environment. Additionally, an audio source associated with the speaker entity may be identifiable based on position within a coverage area, beamforming lobe association, or audio characteristics.

The audio signal processing system 100 also includes a beamforming audio processing system 104. The beamforming audio processing system 104 may be configured to perform one or more beamforming processes with respect to the audio stream 106 to provide sound reinforcement audio 108. The sound reinforcement audio 108 may refer to audio that is processed and output to enable listeners in a reinforcement area to hear audio captured from a coverage area with improved clarity, intelligibility, and/or volume. For instance, the sound reinforcement audio 108 may be an enhanced version of the audio stream 106 to enable desirable and/or appropriately processed audio for a reinforcement area of an audio environment as compared to a coverage area of the audio environment associated with capture of audio for the audio stream 106. In some examples, the sound reinforcement audio 108 includes beamformed audio data that is digitally processed to enhance audio of the audio stream 106 for a particular reinforcement area.

The sound reinforcement audio 108 may include audio that has been amplified, equalized, filtered, denoised, dereverberated, speech-shaped, and/or otherwise enhanced via signal processing associated with the sound reinforcement engine 110. In some examples, the sound reinforcement audio 108 may be transmitted to a far-end of a conferencing call, such as remote participants in a video conference or audio conference.

In some examples, the sound reinforcement audio 108 may be transmitted to an in-room audio system to enable listeners within the audio environment to hear audio from the coverage area with improved clarity. For instance, in a classroom scenario, the sound reinforcement audio 108 may enable students in a near-end reinforcement area to hear a lecturer through a microphone-to-processor-to-speaker signal path, while also enabling far-end remote participants to hear the lecturer through a microphone-to-processor-to-codec signal path.

Additionally, the sound reinforcement audio 108 may include: an audio stream, a video stream, broadcast audio, broadcast video, speech reinforcement audio, a control signal, visual data for rendering via an electronic interface, training data for one or more machine learning models, and/or other output data. The sound reinforcement audio 108 may be specifically processed based on audio output requirements of one or more output devices associated with a reinforcement area, including requirements related to frequency response, dynamic range, latency, and/or spatial audio characteristics.

The beamforming audio processing system 104 may generate the sound reinforcement audio 108 independent of the number of capture devices 102 or output devices. For example, by utilizing the coverage area and/or reinforcement areas in an audio environment, the beamforming audio processing system 104 may enable consistent results regardless of the quantity of capture devices 102 used in a coverage area and/or regardless of the quantity of output devices used in a reinforcement area. As such, the beamforming audio processing system 104 may allow scalability for selective beamforming muting associated with an audio environment while maintaining system performance. For example, seamless expansion or reduction of capture devices 102 and/or output devices may be provided for selective beamforming muting without compromising performance of the audio signal processing system 100.

The beamforming audio processing system 104 depicted in FIG. 1 includes a sound reinforcement engine 110 and/or a beamforming muting engine 112. The beamforming audio processing system 104 may utilize the sound reinforcement engine 110 to convert the audio stream 106 into the sound reinforcement audio 108. For instance, the sound reinforcement engine 110 may apply signal processing associated with sound reinforcement to the one or more portions of the audio stream 106. In some examples, the sound reinforcement engine 110 may provide audio processing related to sound reinforcement to amplify, equalize, filter, and/or otherwise enhance the audio stream 106 to provide the sound reinforcement audio 108. For instance, the sound reinforcement engine 110 may perform equalization and/or gain adjustment with respect to the audio stream 106 to reduce overall latency between the audio stream 106 and the sound reinforcement audio 108.

The sound reinforcement engine 110 may also perform denoising, dereverberation, speech shaping, artifacts reduction, acoustic echo cancellation (AEC), and/or other audio processing with respect to the audio stream 106. In some examples, the sound reinforcement engine 110 may mute undesirable audio artifacts associated with the audio stream 106. For instance, the sound reinforcement engine 110 may mute audio coverage in the audio environment where undesirable audio artifacts may be provided. In a conference room audio environment, undesirable audio artifacts may include noise associated with a heating, ventilation, and air conditioning (HVAC) system, a projector, undesirable talkers, or another undesirable audio source. As such, muting functionality associated with the sound reinforcement audio 108 may be provided with lower latency as compared to other artifact reduction processing techniques associated with the audio stream 106.

The sound reinforcement engine 110 may also output the sound reinforcement audio 108 via one or more output devices (e.g., one or more audio output devices) associated with a reinforcement area of an audio environment. As such, the sound reinforcement audio 108 may enable an improved listening experience for listeners in the reinforcement area via the signal processing associated with the sound reinforcement engine 110. Moreover, the sound reinforcement audio 108 may be specifically processed based on audio output requirements of the one or more output devices associated with a reinforcement area.

The one or more output devices may include one or more of: a speaker, a speaker array, headphones, earphones, a codec (e.g., coder-decoder) device, an audio mixer device, a smartphone, a tablet computer, a laptop, a personal computer, an audio workstation device, a wearable device, an augmented reality device, a virtual reality device, a broadcasting device, a recording device, a haptic device, or another type of output device. Additionally, the sound reinforcement audio 108 may include: an audio stream, a video stream, broadcast audio, broadcast video, speech reinforcement audio, a control signal, visual data for rendering via an electronic interface, training data for one or more machine learning models, and/or other output data.

In some examples, the one or more output devices may be associated with a reinforcement area of the audio environment. For example, the one or more output devices may be located within the reinforcement area or proximate to the reinforcement area to enable output of the sound reinforcement audio 108 via the reinforcement area. A reinforcement area may be an area within an audio environment where a processed version of the audio stream 106 (e.g., the sound reinforcement audio 108) is reproduced and/or distributed via the one or more output devices. The reinforcement area may be distinct from the coverage area associated with capture of the audio stream 106 via the one or more capture devices 102.

Additionally, the reinforcement area may be configured to provide enhanced, amplified, and/or otherwise processed audio for listeners or audience members associated with the audio environment and/or a virtual platform for the audio environment. In some examples, the sound reinforcement engine 110 may add a certain degree of delay to the sound reinforcement audio 108 to maintain a desirable degree of latency between the coverage area and the reinforcement area. In some examples, the sound reinforcement engine 110 may determine the degree of delay based on a distance between the coverage area and the reinforcement area. For instance, the sound reinforcement engine 110 may apply a certain degree of delay to maintain latency at 3 milliseconds or less per meter between the coverage area and the reinforcement area.

The beamforming audio processing system 104 may utilize the beamforming muting engine 112 to apply selective muting to the audio stream 106. For instance, the beamforming muting engine 112 may provide selective beamforming muting for one or more beamformed lobes of the one or more capture devices 102. In some examples, the beamforming muting engine 112 may provide selective beamforming muting for one or more beamformed lobes of a microphone array that captures the audio stream 106.

In some examples, the beamforming muting engine 112 may apply selective muting to the audio stream 106 based on a muting instruction signal 114. The muting instruction signal 114 may refer to a signal that includes information for instructing the beamforming audio processing system 104 to selectively mute or unmute audio associated with one or more coverage areas, beamforming lobes, audio sources, and/or sound reinforcement audio channels within an audio environment. The muting instruction signal 114 may include information for instructing the beamforming audio processing system 104 to selectively mute or unmute a particular portion of the audio stream 106, one or more particular beamforming lobes of the one or more capture devices 102, and/or one or more particular areas within an audio environment. In some examples, the muting instruction signal 114 may include information for instructing the beamforming audio processing system 104 to selectively mute or unmute audio associated with a particular sound reinforcement audio channel associated with a coverage area of an audio environment.

The muting instruction signal 114 may be associated with a coverage area identifier corresponding to the coverage area of the audio environment deemed desirable for selecting muting. In some examples, the muting instruction signal 114 may include the coverage area identifier. In other examples, the beamforming muting engine 112 may determine the coverage area identifier based on the muting instruction signal 114. For instance, the coverage area identifier may be previously stored by the beamforming audio processing system 104 and/or the one or more capture devices 102. The coverage area identifier may refer to information that corresponds to a particular coverage area within an audio environment. In some examples, the coverage area identifier may comprise a numerical value, an alphanumeric string, coordinate data, zone designation data, and/or other data that uniquely identifies a coverage area.

The muting instruction signal 114 may additionally include metadata associated with information regarding the coverage area. For instance, the metadata may indicate an identifier for respective capture devices 102 associated with the coverage area, an identifier for respective beamforming lobes configured to capture audio from the coverage area, a timestamp associated with the muting instruction, a duration for the muting instruction, and/or other information related to the selective muting.

The muting instruction signal 114 may be generated in response to various types of user input, including activation of a physical button (e.g., a physical mute-button near a set of desks or tables, or near a given seat or section in a room), activation of an interactive element of a user interface (e.g., a digital button, a digital slider, or a digital toggle switch), detection of a predefined word or phrase via speech recognition, detection of a predefined gesture via gesture recognition, and/or transmission via a communication channel associated with an application programming interface.

The coverage area identifier may be defined for the coverage area during system setup or calibration of the one or more capture devices 102 for the audio environment. The beamforming muting engine 112 may determine the coverage area identifier based on: a positioning system (e.g., radio frequency identification (RFID) or short-range wireless technology beacons, etc.) integrated with the one or more capture devices 102, an acoustic mapping associated with a spatial representation of the audio environment and/or respective coverage areas of the audio environment, and/or beamforming analysis with respect to the audio stream 106 to determine direction and/or spread of microphone patterns associated with the one or more capture devices 102.

In some examples, the beamforming muting engine 112 may determine the coverage area identifier based on one or more machine learning models trained to analyze audio patterns, speaker locations, and/or room acoustics of the audio environment over time. For instance, the one or more machine learning models may utilize one or more machine learning techniques to learn and/or adapt to characteristics of an audio environment. In some examples, a machine learning model may be a neural network model, a hidden Markov model, a support vector machine, a decision tree model, a random forest model, or another type of machine learning model. A machine learning model may be trained using supervised learning, unsupervised learning, reinforcement learning, or a combination thereof.

In some examples, a machine learning model may be configured to identify and track audio sources within the audio environment based on acoustic features extracted from the audio stream. Additionally, a machine learning model may be configured to learn spatial characteristics of the audio environment, including room dimensions, surface materials, reverberation patterns, and/or acoustic reflections. In some examples, a machine learning model may be configured to adapt to changes in the audio environment over time, such as changes in speaker positions, changes in room configuration, and/or changes in ambient noise conditions. In some examples, a machine learning model may utilize extracted acoustic features such as Mel-frequency cepstral coefficients (MFCCs), spectral features, or other time-frequency representations of the audio stream to analyze audio patterns. Further, a machine learning model may be configured to determine a coverage area identifier based on learned associations between audio characteristics and coverage areas within the audio environment.

The beamforming muting engine 112 may determine the coverage area identifier based on one or more audio source localization techniques associated with the audio stream 106 to determine a location of one or more audio sources within the audio environment and/or respective coverage areas of the audio environment. In some examples, the beamforming muting engine 112 may determine the coverage area identifier based on a user interface mapping of respective locations of the one or more capture devices 102 generated via a user interface that enables defining and/or adjustment of coverage areas within the audio environment.

Based on the muting instruction signal 114 and/or the coverage area identifier associated with the muting instruction signal 114, the beamforming muting engine 112 may disable a sound reinforcement audio channel between the coverage area and the reinforcement area to discontinue the output of the sound reinforcement audio 108 via the one or more output devices. Disabling of the sound reinforcement audio channel may refer to discontinuing, interrupting, or preventing transmission of the sound reinforcement audio via an audio signal path between the coverage area and the reinforcement area of the audio environment. Disabling a sound reinforcement audio channel may include applying one or more source removal techniques to prevent sound reinforcement audio from being output to a reinforcement area via one or more output devices. For example, muting may be selectively applied to the sound reinforcement audio channel to mute the sound reinforcement audio 108 associated with the coverage area.

In some examples, disabling a sound reinforcement audio channel may include applying beamforming nulling to one or more beamforming lobes of one or more capture devices to create a null in a beam pattern directed toward the coverage area and/or to prevent the sound reinforcement audio from being output to the reinforcement area. Disabling a sound reinforcement audio channel may also include active removal of audio content from a targeted beamforming lobe and one or more other beamforming lobes (e.g., one or more other gated beamforming lobes) of the one or more capture devices.

In some examples, disabling a sound reinforcement audio channel may include adjusting gain of an audio output device to prevent the sound reinforcement audio from being output to the reinforcement area. Disabling a sound reinforcement audio channel may also include transmitting a source removal instruction signal to the one or more capture devices 102 to enable discontinuation of the output of the sound reinforcement audio via one or more output devices.

The sound reinforcement audio channel may be an audio signal path that enables transmission of audio between the coverage area and the reinforcement area. In some examples, the sound reinforcement audio channel may include an input stage associated with the one or more capture devices 102, an audio transmission stage associated with wired or wireless transmission of audio, and an output stage associated with the one or more output devices.

The sound reinforcement audio channel may also enable capture, processing, and/or reproduction of audio to reinforce one or more portions of an audio stream from the coverage area in the reinforcement area while maintaining and enhancing audio quality of the audio stream. For instance, the sound reinforcement audio channel may enable audio for a meeting participant to be sent to a far end of a conferencing call or to an in-room voice-lift system. As such, the sound reinforcement audio channel may enable capture, processing, and/or reproduction of audio to reinforce one or more portions of the audio stream 106 from the coverage area in the reinforcement area while maintaining and/or enhancing audio quality of the audio stream 106 via output of the sound reinforcement audio 108.

In some examples, the beamforming muting engine 112 may generate a source removal instruction signal 116 based on the muting instruction signal 114 and/or the coverage area identifier associated with the muting instruction signal 114 to disable the sound reinforcement audio channel between the coverage area and the reinforcement area. The source removal instruction signal 116 may be provided to the one or more capture devices 102 to enable discontinuation of the output of the sound reinforcement audio 108 via the one or more output devices.

The source removal provided by the source removal instruction signal 116 may include removal of undesirable audio content from a target source. For example, the source removal instruction signal 116 may include a muting instruction for one or more beamforming lobes of the one or more capture devices 102 to enable discontinuation of the output of the sound reinforcement audio 108 via the one or more output devices. In some examples, the source removal instruction signal 116 may cause DSP muting to the sound reinforcement audio channel to prevent the sound reinforcement audio 108 from being output to the reinforcement area via the one or more output devices. In some examples, the source removal instruction signal 116 may cause beamforming nulling to one or more beamforming lobes of the one or more capture devices 102 to create a null in a beam pattern directed toward the coverage area and/or to prevent the sound reinforcement audio 108 from being output to the reinforcement area via the one or more output devices.

The source removal instruction signal 116 may also cause active removal of audio content from a targeted beamforming lobe and one or more other beamforming lobes (e.g., one or more other gated beamforming lobes) of the one or more capture devices 102. Additional details related to source removal techniques are discussed in detail in connection with the audio processing systems disclosed in commonly owned U.S. Patent Application Ser. No. 18/309,441, titled “AUDIO SOURCE FEATURE SEPARATION AND TARGET AUDIO SOURCE GENERATION,” and filed on Apr. 28, 2023, which is hereby incorporated by reference in its entirety. However, it is to be appreciated that, in some examples, another type of audio processing technique may be implemented to disable the sound reinforcement audio channel between the coverage area and the reinforcement area.

In some examples, the source removal instruction signal 116 may be alternatively provided to an audio output device based on the muting instruction signal 114 to prevent the sound reinforcement audio 108 from being output to the reinforcement area. For instance, the source removal instruction signal 116 may be utilized to adjust gain of the audio output device to prevent the sound reinforcement audio 108 from being output to the reinforcement area. In some examples where multiple audio output devices are located in a reinforcement area, the source removal instruction signal 116 may be alternatively provided to an output device such as an audio mixer device to appropriately adjust gain for the respective audio output devices. As such, precise control over output of the sound reinforcement audio 108 may be provided in a reinforcement area.

In some examples, the one or more capture devices 102 may include a dedicated beamforming lobe associated with an undesirable audio location within the audio environment. The undesirable audio location may refer to a location within an audio environment where audio capture is not desired for transmission to a reinforcement area. Additionally, the beamforming audio processing system 104 may receive the audio stream 106 from the dedicated beamforming lobe associated with the undesirable audio location and the beamforming audio processing system 104 may apply selective beamforming muting to discontinue output of sound reinforcement audio associated with the undesirable audio location.

The one or more capture devices 102 may also be configured to capture audio from one or more speaker entities within a coverage area of an audio environment. Additionally, the beamforming audio processing system 104 may identify an audio source associated with a speaker entity within the coverage area and may disable a beamforming lobe associated with the audio source based on the muting instruction signal 114.

In some examples, the beamforming audio processing system 104 may identify two or more beamforming lobes associated with an audio source of a speaker entity based on the audio stream 106. For instance, a speaker entity may be positioned within the audio environment such that audio from the speaker entity is captured by two or more beamforming lobes of the one or more capture devices 102. The beamforming muting engine 112 may analyze the audio stream 106 to determine which beamforming lobes are capturing audio from the speaker entity. Based on the muting instruction signal 114, the beamforming audio processing system 104 may disable the two or more beamforming lobes associated with the audio source to discontinue output of sound reinforcement audio associated with the speaker entity.

In some examples, the beamforming audio processing system 104 may identify a position of an audio source associated with a speaker entity within the coverage area. For instance, the beamforming audio processing system 104 may utilize one or more audio source localization techniques, positioning systems (e.g., RFID or short-range wireless technology beacons), acoustic mapping, and/or one or more machine learning models to determine the position of the audio source within the coverage area. Based on the muting instruction signal 114 and the position of the audio source within the coverage area, the beamforming audio processing system 104 may disable a beamforming lobe associated with the audio source. The beamforming audio processing system 104 may also dynamically track the position of the speaker entity within the audio environment and may adjust which beamforming lobes are muted as the position of the speaker entity changes.

Accordingly, the beamforming audio processing system 104 may provide improved sound reinforcement and/or selective muting for the audio stream 106 as compared to traditional beamforming techniques. For example, the beamforming audio processing system 104 may provide intelligent muting of an audio source associated with the audio stream 106, thereby enabling optimal privacy with respect to the reinforcement area of the audio environment.

Additionally, accuracy of muting and/or filtering of a sound source in a coverage area of an audio environment may be improved by employing the beamforming audio processing system 104. The beamforming audio processing system 104 may additionally or alternatively be adapted to produce improved audio signals with reduced noise and/or other undesirable audio artifacts even in view of audio latency requirements for real time audio processing and/or video processing associated with an audio environment. For example, the beamforming audio processing system 104 may mute undesirable audio for one or more audio source locations in a coverage area while maintaining audio latency requirements for providing audio for one or more other audio source locations and/or a real-time video stream associated with the audio environment. As such, an audio stream may be provided to a reinforcement area without the undesirable audio portions. The beamforming audio processing system 104 may also improve runtime efficiency of muting, audio filtering, denoising, and/or other audio processing while also optimizing beamforming of audio for an audio environment. Moreover, the beamforming audio processing system 104 may be implemented without synchronizing microphone components of different microphone arrays with a single clock structure.

Another technical problem solved by the beamforming audio processing system 104 is the unintended capture of audio from areas outside of direct beamforming coverage. The beamforming audio processing system 104 ability to dynamically configure and selectively mute individual beamforming lobes allows for improved privacy and filtering of undesirable audio sources. This is particularly beneficial in courtrooms or classrooms scenarios mentioned above where temporary exclusion of certain audio sources is necessary without disrupting the overall audio capture and reinforcement.

The beamforming audio processing system 104 also addresses the challenge of real-time audio source tracking and muting in dynamic environments. By utilizing advanced signal processing techniques, speech recognition, and/or gesture recognition, the beamforming audio processing system 104 may intelligently identify audio sources associated with undesirable audio within an audio environment. This enables seamless and accurate muting of specific speakers, audio sources, or coverage areas within an audio environment, even as positions of speakers and/or audio sources change within the audio environment.

Another technical problem overcome by the beamforming audio processing system 104 is the need for flexible and customizable muting control in various audio setups. The ability of the beamforming audio processing system 104 to utilize muting instruction signals through multiple interfaces - including physical buttons, graphical user interfaces, voice commands, and gestures - provides unprecedented adaptability for different use cases and user preferences. This flexibility allows for more efficient deployment and operation of beamforming microphone arrays in diverse audio environments.

The beamforming audio processing system 104 also solves the challenge of maintaining audio quality and intelligibility while selectively muting certain audio sources. By applying sophisticated signal processing techniques to generate and/or selectively mute the sound reinforcement audio, the beamforming audio processing system 104 ensures that the remaining active audio sources are clearly captured and reproduced, even when portions of the audio environment are muted. This maintains the overall integrity of the audio experience for listeners in the reinforcement area.

The beamforming audio processing system 104 may also employ fewer computing resources when compared to traditional audio processing systems that are used for beamforming. Additionally or alternatively, in some examples, the beamforming audio processing system 104 may be configured to deploy a smaller number of memory resources allocated to beamforming, audio muting, and/or other audio filtering for an audio stream sample such as, for example, the audio stream 106. In some examples, the beamforming audio processing system 104 may be configured to improve processing speed of beamforming operations, audio muting operations, and/or audio filtering operations. These improvements may enable an improved audio processing systems to be deployed in microphones, audio conferencing processors, and/or other hardware/software configurations where processing and memory resources are limited, and/or where processing speed and efficiency is important for functionality of an audio system.

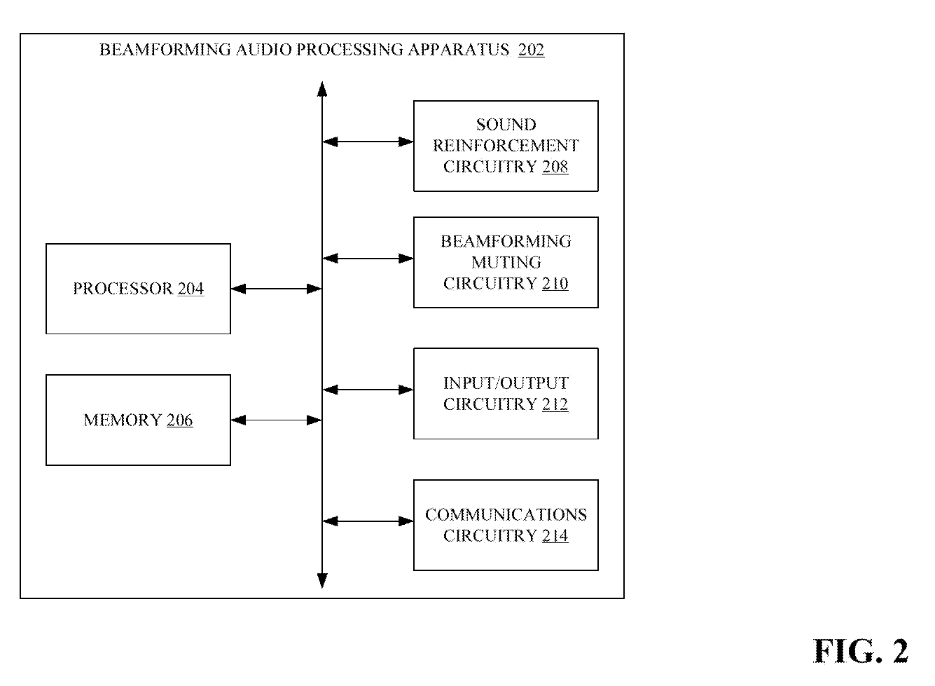

FIG. 2 illustrates an example beamforming audio processing apparatus 202 configured in accordance with one or more embodiments of the present disclosure. The beamforming audio processing apparatus 202 may be configured to perform one or more techniques described in FIG. 1 and/or one or more other techniques described herein.

The beamforming audio processing apparatus 202 may be a computing system communicatively coupled with one or more circuit modules related to audio processing. The beamforming audio processing apparatus 202 may comprise or otherwise be in communication with a processor 204, a memory 206, sound reinforcement circuitry 208, beamforming muting circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise audio data, stereo audio signal data, mono audio signal data, radio frequency signal data, SRP transformation data, a set of SRP weights, or the like, for enabling the beamforming audio processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading. In some examples, the processor 204 may be an audio conferencing processor.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an example of the present disclosure described herein. For example, when the processor 204 is embodied as a CPU, DSP, ARM, FPGA, ASIC, or similar, the processor may be configured as hardware for conducting the operations of an example of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an example of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the beamforming audio processing apparatus 202 may comprise the sound reinforcement circuitry 208. The sound reinforcement circuitry 208 may be any means embodied in either hardware or a combination of hardware and software that is configured to perform one or more functions disclosed herein related to the sound reinforcement engine 110. In one or more examples, the beamforming audio processing apparatus 202 may comprise the beamforming muting circuitry 210. The beamforming muting circuitry 210 may be any means embodied in either hardware or a combination of hardware and software that is configured to perform one or more functions disclosed herein related to the beamforming muting engine 112.

In some examples, the beamforming audio processing apparatus 202 may comprise the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the beamforming audio processing apparatus 202 may comprise the communications circuitry 214. The communications circuitry 214 may be any means embodied in either hardware or a combination of hardware and software that is configured to receive and/or transmit data from/to a network and/or any other device or module in communication with the beamforming audio processing apparatus 202. In this regard, the communications circuitry 214 may comprise, for example, an antennae or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

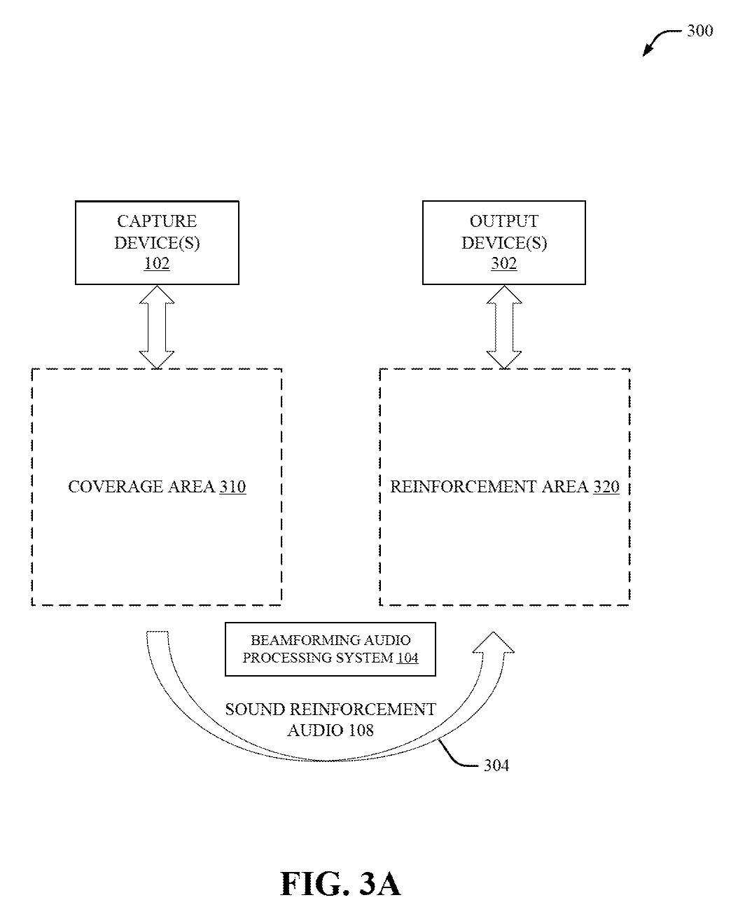

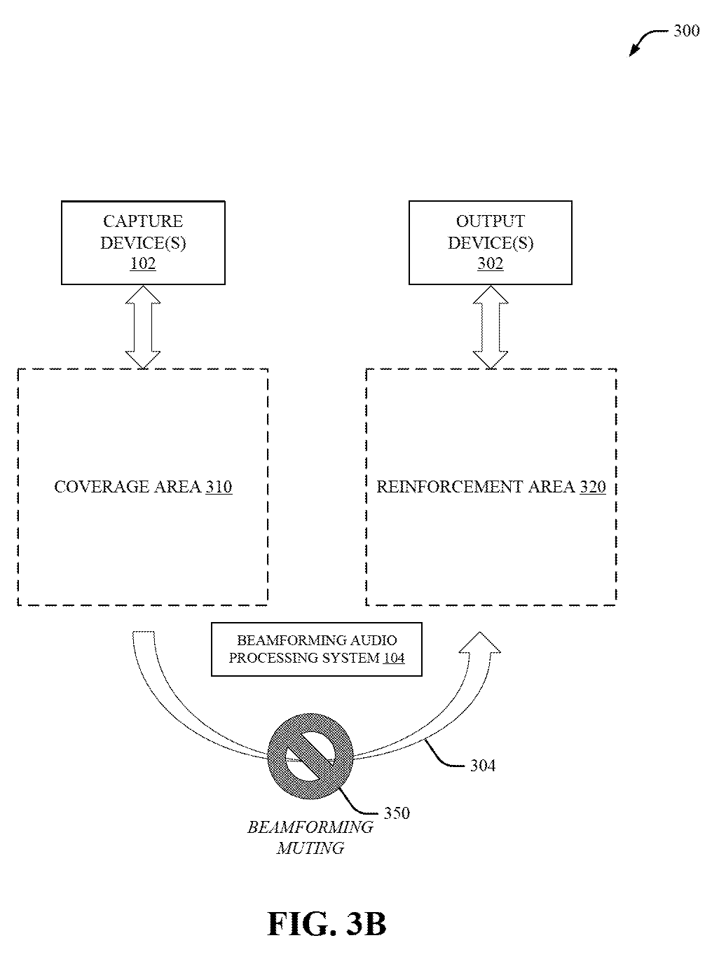

FIG. 3A illustrates an audio environment 300 associated with sound reinforcement enabled by the beamforming audio processing system 104 of FIG. 1 according to one or more embodiments of the present disclosure. The audio environment 300 includes a coverage area 310 and a reinforcement area 320.

The coverage area 310 may represent a defined region within the audio environment 300 where the one or more capture devices 102 are configured to capture audio associated with the audio stream 106. The one or more capture devices 102 may be located within the coverage area 310 or proximate to the coverage area 310 to enable capture of at least a portion of the audio stream 106 via the coverage area 310. For example, the coverage area 310 may be an area within the audio environment 300 that is associated with one or more audio sources that provide at least a portion of audio for the audio stream 106.

The coverage area 310 may be determined based on factors such as placement and characteristics of the one or more capture devices 102, acoustic properties of the audio environment 300, and/or expected locations of audio sources within the audio environment 300. In some examples, the coverage area 310 may be defined by one or more directional sensitivity patters associated with beamforming.

The reinforcement area 320 may represent a zone within the audio environment 300 where a processed audio stream (e.g., the sound reinforcement audio 108) is reproduced or output. The reinforcement area 320 may be associated with one or more output devices 302 configured to distribute audio associated with the processed audio stream (e.g., the sound reinforcement audio 108) throughout the reinforcement area 320. For example, the one or more output devices may be located within the reinforcement area 320 or proximate to the reinforcement area 320 to enable output of the sound reinforcement audio 108 via the reinforcement area 320.

The reinforcement area 320 may be an area within the audio environment 300 where a processed version of the audio stream 106 (e.g., the sound reinforcement audio 108) is reproduced and/or distributed via the one or more output devices 302. The reinforcement area 320 may be distinct from the coverage area 310. In other examples, at least a portion of the reinforcement area 320 may overlap the coverage area 310. In some examples, the beamforming audio processing system 104 may utilize one or more digital feedback reduction techniques to mitigate or prevent acoustic feedback when at least a portion of the reinforcement area 320 overlaps the coverage area 310. For instance, the beamforming audio processing system 104 may apply one or more digital feedback reduction techniques such that reinforcement gain is reduced to maintain audio quality and/or prevent acoustic feedback. Additionally, the reinforcement area 320 may be configured to provide enhanced, amplified, and/or otherwise processed audio for listeners or audience members associated with the audio environment 300 and/or a virtual platform for the audio environment 300.

The coverage area 310 and the reinforcement area 320 may be interconnected by a sound reinforcement audio channel 304 enabled via beamforming and/or sound reinforcement associated with the beamforming audio processing system 104. The sound reinforcement audio channel 304 may provide a signal path for transmitting the sound reinforcement audio 108 from the beamforming audio processing system 104 to the one or more output devices 302. For example, the beamforming audio processing system 104 may be configured to receive the audio stream 106 captured from the coverage area 310 by the one or more capture devices 102.

After receiving the audio stream 106, the beamforming audio processing system 104 may process the audio stream 106 to generate the sound reinforcement audio 108. The sound reinforcement audio 108 may be transmitted via the sound reinforcement audio channel 304 to the one or more output devices 302 for reproduction within the reinforcement area 320. In some examples, the sound reinforcement audio channel 304 may transmit processed audio signals that have been enhanced, amplified, or otherwise modified by the beamforming audio processing system 104 to improve audio quality and intelligibility within the reinforcement area 320.

In some examples, the beamforming audio processing system 104 may convert an audio format or sampling rate of the sound reinforcement audio 108 to optimize transmission of the sound reinforcement audio 108 via the sound reinforcement audio channel 304. In some examples, the beamforming audio processing system 104 may additionally or alternatively dynamically adjust a bitrate of the sound reinforcement audio 108 to optimize transmission of the sound reinforcement audio 108 via the sound reinforcement audio channel 304. In some examples, the one or more output devices 302 may apply signal compression, error correction, and/or other digital signal processing to the sound reinforcement audio 108 to further enhance audio output via the reinforcement area 320.

FIG. 3B further illustrates the audio environment 300 associated with selective beamforming muting enabled by the beamforming audio processing system 104 of FIG. 1 according to one or more embodiments of the present disclosure. The audio environment 300 includes the coverage area 310 and the reinforcement area 320.

Based on the muting instruction signal 114, the sound reinforcement audio channel 304 interconnected between the coverage area 310 and the reinforcement area 320 may be disabled to discontinue output of the sound reinforcement audio 108 via the one or more output devices 302. For example, the beamforming audio processing system 104 may apply beamforming muting 350 to the sound reinforcement audio channel 304 and/or one or more beamforming lobes associated with the one or more capture devices 102 to discontinue output of the sound reinforcement audio 108 via the one or more output devices 302. Accordingly, the beamforming muting 350 may enable granular control over sound reinforcement associated with the reinforcement area 320. Additionally, the beamforming muting 350 may enable intelligent audio source removal for the reinforcement area 320.

The coverage area 310 may be additionally associated with one or more output devices. For example, the sound reinforcement audio channel 304 between the coverage area 310 and the reinforcement area 320 may be disabled responsive to the muting instruction signal 114. Additionally, predefined audio may be output via one or more output devices associated with the coverage area 310.

The predefined audio may refer to audio that is output via one or more output devices to provide an acoustic barrier between a coverage area and a reinforcement area of an audio environment. In some examples, the predefined audio may be noise or other type of audio to further provide an acoustic barrier between the coverage area 310 and the reinforcement area 320. For instance, the predefined audio may include white noise, pink noise, or another type of noise to provide an acoustic barrier between the coverage area 310 and the reinforcement area 320.

Additionally, the type of predefined audio may be selected based on conditions associated with the audio environment 300 and/or a desirable degree of acoustic separation between the coverage area 310 and the reinforcement area 320. For instance, either white noise or pink noise may be selected based on conditions associated with the audio environment 300 and/or a desirable degree of acoustic separation between the coverage area 310 and the reinforcement area 320.

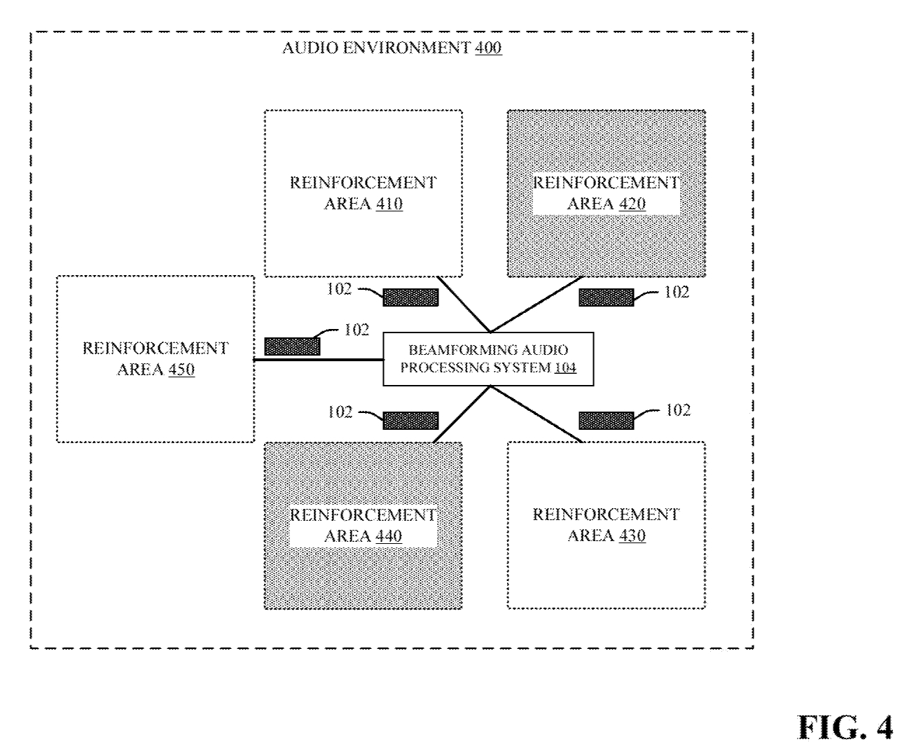

FIG. 4 illustrates an audio environment 400 associated with sound reinforcement and selecting selective beamforming muting enabled by the beamforming audio processing system 104 of FIG. 1 according to one or more embodiments of the present disclosure. The audio environment 400 includes a reinforcement area 410, a reinforcement area 420, a reinforcement area 430, a reinforcement area 440, and a reinforcement area 450. The audio environment 400 also includes a respective capture device 102 respectively associated with the reinforcement area 410, the reinforcement area 420, the reinforcement area 430, the reinforcement area 440, and the reinforcement area 450.

The beamforming audio processing system 104 may selectively mute audio output for a subset of the reinforcement area 410, the reinforcement area 420, the reinforcement area 430, the reinforcement area 440, and the reinforcement area 450. For example, different audio sources within the audio environment 400 may be respectively associated with the reinforcement area 410, the reinforcement area 420, the reinforcement area 430, the reinforcement area 440, and the reinforcement area 450. Accordingly, based on a muting instruction signal associated with a particular audio source, the beamforming audio processing system 104 may disable a sound reinforcement audio channel for a corresponding reinforcement area from the reinforcement area 410, the reinforcement area 420, the reinforcement area 430, the reinforcement area 440, and the reinforcement area 450. In a non-limiting example, the beamforming audio processing system 104 may selectively mute audio output for the reinforcement area 420 and the reinforcement area 440 while allowing audio output via the reinforcement area 410, the reinforcement area 430, and the reinforcement area 450.

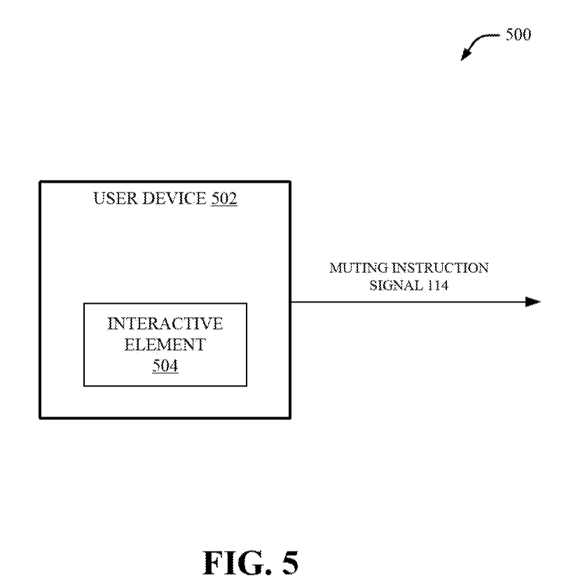

FIG. 5 illustrates a system 500 associated with generation of the muting instruction signal 114 utilized by the beamforming audio processing system 104 of FIG. 1 according to one or more embodiments of the present disclosure. The system 500 includes a user device 502. The user device 502 may be a digital conference device, a wireless conference unit, an audio workstation device, a laptop, a personal computer, a smartphone, an augmented reality device, a virtual reality device, a microphone (e.g., a conferencing microphone, a table microphone array, etc.), headphones, earphones, or another type of user device. The user device 502 may include an interactive element 504. The interactive element 504 may be configured to receive user input for initiating generation of the muting instruction signal 114. For example, the user device 502 may be configured to generate the muting instruction signal 114 in response to user interaction with the interactive element 504.

Upon receiving user input via the interactive element 504, the user device 502 may process the input and generate the muting instruction signal 114. The muting instruction signal 114 may include information for instructing the beamforming audio processing system 104 to selectively mute or unmute specific portions of the audio stream 106 and/or specific areas within an audio environment. For instance, the muting instruction signal 114 may include a coverage area identifier corresponding to the coverage area of the audio environment.

The coverage area identifier may refer to information that corresponds to a particular coverage area within an audio environment. The coverage area identifier may comprise a numerical value, an alphanumeric string, coordinate data, zone designation data, and/or other data that uniquely identifies a coverage area. In some examples, a coverage area identifier may be defined for a coverage area during system setup or calibration of one or more capture devices for an audio environment. In some examples, a coverage area identifier may be determined based on a positioning system integrated with one or more capture devices, an acoustic mapping associated with a spatial representation of an audio environment, beamforming analysis with respect to an audio stream, one or more machine learning models trained to analyze audio patterns, one or more audio source localization techniques, or a user interface mapping of respective locations of one or more capture devices. For instance, a coverage area identifier may correspond to a set of desks or tables, a given seat or section in a room, a student section of a lecture room, or a lecturer's podium area.

In some examples, the muting instruction signal 114 may additionally include metadata associated with information regarding the coverage area. For instance, the metadata may indicate an identifier for respective capture devices 102 associated with the coverage area, an identifier for respective beamforming lobes configured to capture audio from the coverage area, etc. In some examples, the user device 502 may be configured to transmit the muting instruction signal 114 to the beamforming audio processing system 104 to enable the selective muting control via the beamforming audio processing system 104, thereby allowing users to manage audio capture and/or sound reinforcement associated with one or more areas of an audio environment. In some examples, the user device 502 may transmit the muting instruction signal 114 via a communication channel associated with an application programming interface.

In some examples, the interactive element 504 may comprise a graphical user interface component for a user interface, such as but is not limited to: a digital button, a digital slider, a digital toggle switch, or another type of suitable interface element for receiving user input via a user interface. In other examples, the interactive element 504 may comprise a physical interface element on the user device 502, such as but is not limited to: a physical button (e.g., a physical mute-button), a physical slider, a physical toggle switch, or another type of suitable physical interface element for receiving user input via the user device 502.

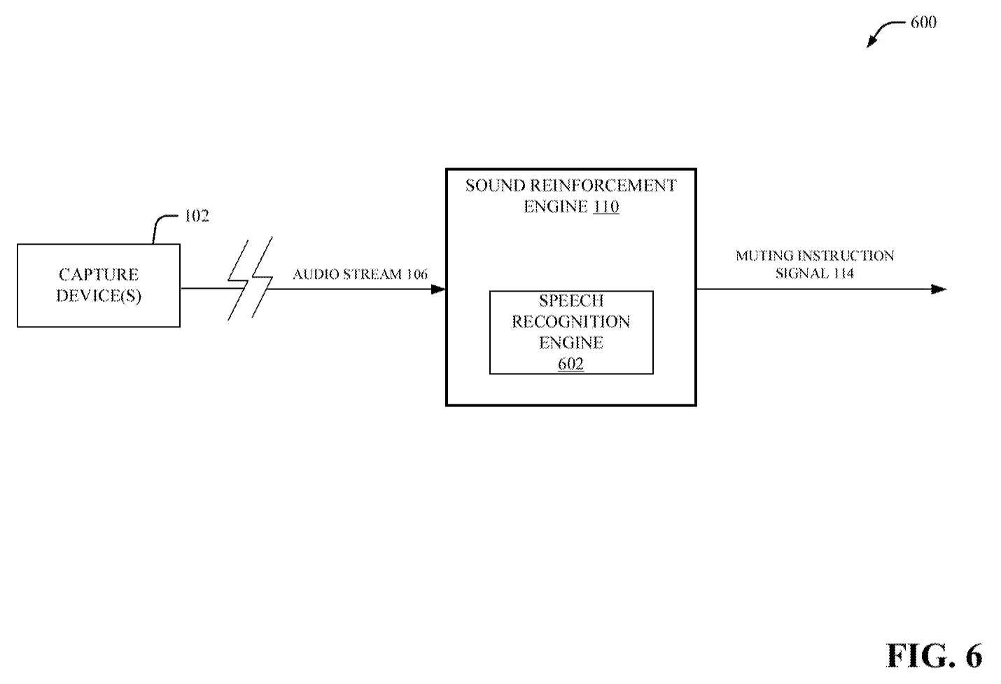

FIG. 6 illustrates a system 600 associated with generation of the muting instruction signal 114 utilized by the beamforming audio processing system 104 of FIG. 1 via speech recognition according to one or more embodiments of the present disclosure. The system 600 includes the sound reinforcement engine 110. In some examples, the sound reinforcement engine 110 includes a speech recognition engine 602.

The speech recognition engine 602 may be configured to apply one or more speech recognition techniques to the audio stream 106 provided by the one or more capture devices 102 to initiate generation of the muting instruction signal 114. For example, the speech recognition engine 602 may be configured to generate the muting instruction signal 114 in response to detection of a particular word or phrase in the audio stream 106.

The muting instruction signal 114 may include information for instructing the beamforming muting engine 112 to selectively mute or unmute specific portions of the audio stream 106 and/or specific areas within an audio environment. In some examples, the sound reinforcement engine 110 may provide the muting instruction signal 114 to the beamforming muting engine 112 to enable the selective muting control via the beamforming muting engine 112, thereby allowing users to manage audio capture and/or sound reinforcement associated with one or more areas of an audio environment.

The speech recognition engine 602 may also preprocess the audio stream 106 to enhance speech quality and/or reduce background noise associated with the audio stream 106 to enable the one more speech recognition techniques. The preprocessing may include noise reduction, echo cancellation, audio normalization, and/or one or other types of digital signal processing to transform the audio stream 106 into a format suitable for the one more speech recognition techniques. In some examples, the speech recognition engine 602 may extract relevant acoustic features from the preprocessed audio stream 106, such as but not limited to: MFCCs, spectral features, or other time-frequency representations of the audio stream 106 to enable the one more speech recognition techniques. The speech recognition engine 602 may also be configured to identify one or more predefined keywords or phrases associated with muting commands. In some examples, the speech recognition engine 602 may utilize a list of trigger muting commands to identify the one or more predefined keywords or phrases.

In some examples, the speech recognition engine 602 may repeatedly scan the list of trigger muting commands and compare recognized words or phrases in the audio stream 106 for matches. The speech recognition engine 602 may also utilize one or more DSP techniques to identify a unique audio source within the audio environment. In some examples, the speech recognition engine 602 may utilize confidence scoring to determine a confidence score indicating the likelihood of correct speech recognition with respect to the audio stream 106. As such, the speech recognition engine 602 may enable voice-controlled muting functionality for the beamforming audio processing system 104.

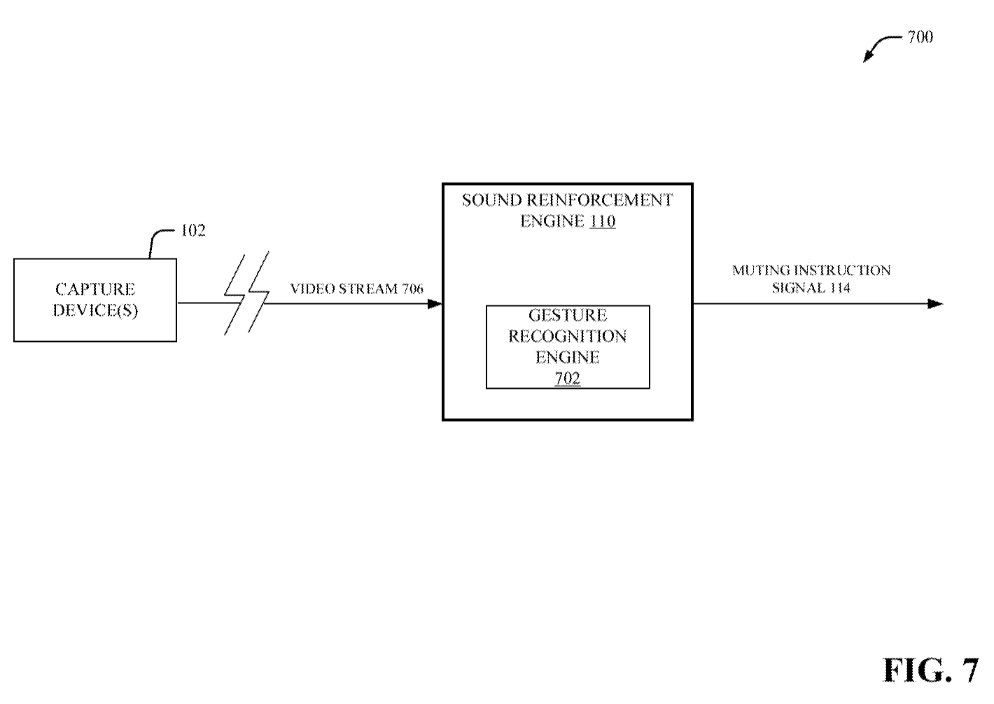

FIG. 7 illustrates a system 700 associated with generation of the muting instruction signal 114 utilized by the beamforming audio processing system 104 of FIG. 1 via gesture recognition according to one or more embodiments of the present disclosure. The system 700 includes the sound reinforcement engine 110. In some examples, the sound reinforcement engine 110 includes a gesture recognition engine 702.

The gesture recognition engine 702 may be configured to apply one or more gesture recognition techniques to a video stream 706 provided by the one or more capture devices 102 to initiate generation of the muting instruction signal 114. In some examples, the video stream 706 includes or is otherwise associated with the audio stream 106. The gesture recognition engine 702 may be configured to generate the muting instruction signal 114 in response to detection of a particular gesture in the video stream 706. The muting instruction signal 114 may include information for instructing the beamforming muting engine 112 to selectively mute or unmute specific portions of the audio stream 106 and/or specific areas within an audio environment. In some examples, the sound reinforcement engine 110 may provide the muting instruction signal 114 to the beamforming muting engine 112 to enable the selective muting control via the beamforming muting engine 112, thereby allowing users to manage audio capture and/or sound reinforcement associated with one or more areas of an audio environment.

The gesture recognition engine 702 may also preprocess the video stream 706 to enhance image quality and/or reduce noise associated with the video stream 706. The preprocessing may include image stabilization, contrast adjustment, background subtraction, and/or one or more other types of preprocessing associated with one or more video frames of the video stream 706. In some examples, the gesture recognition engine 702 may extract individual frames from the video stream 706 at a suitable frame rate for gesture analysis.

The gesture recognition engine 702 may also utilize computer vision and/or a trained machine learning model to detect a speaker within the video frames. In some examples, the gesture recognition engine 702 may utilize one or more DSP techniques to identify a unique audio source (e.g., a speaker) within the audio environment. In some examples, the gesture recognition engine 702 may utilize one or more sensors in the audio environment to identify a unique audio source (e.g., a speaker) within the audio environment. The one or more sensors may include one or more infrared capture devices, one or more acoustic sensor devices, one or more motion sensor devices, one or more proximity sensor devices, one or more depth sensor devices, one or more radar sensor devices, one or more Light Detection and Ranging (LiDAR) sensor devices, one or more time-of-flight (ToF) sensor devices, and/or one or more other types of sensors. As such, the gesture recognition engine 702 may utilize sensor data such as motion sensor data, proximity sensor data, radar sensor data, LiDAR sensor data, TOF sensor data, and/or other sensor data associated with the audio environment to improve detection of an audio source (e.g., a speaker) within the audio environment.

In some examples, the gesture recognition engine 702 may identify and/or track target body points such as hands, arms, and/or head positions of the speaker to identify a predefined gesture related to a muting command. The gesture recognition engine 702 may classify a gesture using a trained machine learning model (e.g., a neural network model, a hidden Markov model, etc.). For example, the trained machine learning model may classify extracted features into predefined gesture categories associated with muting commands. In some examples, the gesture recognition engine 702 may utilize confidence scoring to determine a confidence score indicating the likelihood of correct gesture recognition and/or gesture classification with respect to the video stream 706. As such, the gesture recognition engine 702 may enable gesture-controlled muting functionality for the beamforming audio processing system 104.

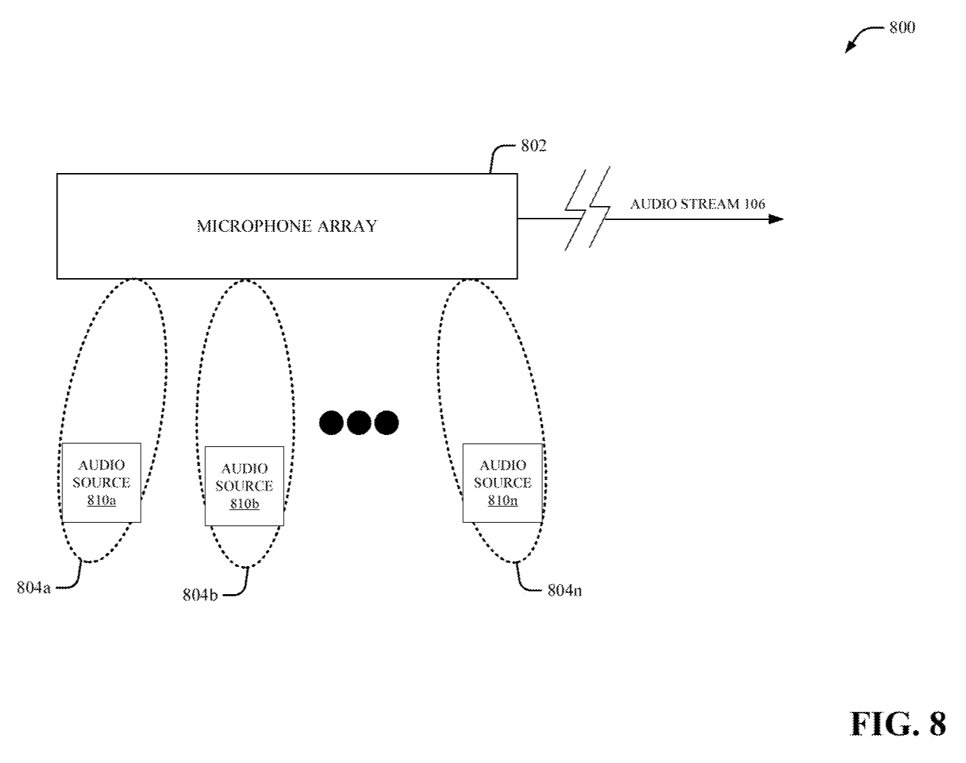

FIG. 8 illustrates a system 800 associated with a microphone array that provides the audio stream 106 processed by the beamforming audio processing system 104 of FIG. 1 according to one or more embodiments of the present disclosure. The system 800 includes a microphone array 802 associated with a plurality of beamforming lobes 804a-n. The microphone array 802 may correspond to the one or more capture devices 102. In some examples, respective beamforming lobes of the plurality of beamforming lobes 804a-n may capture audio associated with one or more audio sources 810a-n. Additionally, respective beamforming lobes of the plurality of beamforming lobes 804a-n may be positioned to capture audio from a respective audio source of the one or more audio sources 810a-n.

The microphone array 802 may be a linear microphone array, a planar microphone array, a circular microphone array, a 2D microphone array, a 3D surface microphone array, a suspended 3D microphone array, a ceiling microphone array, or another type of microphone array. Additionally, a shape of respective beamforming lobes of the plurality of beamforming lobes 804a-n may be a rounded shape to provide a wider beam for capturing audio, an elongated shape to provide a more directed beam for capturing audio, or another type of shape to optimally capture audio associated with one or more audio sources.

The microphone array 802 may covert the audio captured by the plurality of beamforming lobes 804a-n into the audio stream 106 provided as input to the beamforming audio processing system 104. For instance, the microphone array 802 may include a plurality of transducers configured to utilize signal processing techniques to uniformly capture and process sound wave data associated with the one or more audio sources 810a-n. In some examples, the plurality of transducers may be a plurality of micro-electrical mechanical system (MEMS) transducers.

The microphone array 802 may also utilize one or more beamforming techniques to produce the plurality of beamforming lobes 804a-n. In some examples, the plurality of beamforming lobes 804a-n may be a plurality of steerable beamforming lobes. For example, the microphone array 802 may be configured to steer respective beamforming lobes of the plurality of beamforming lobes 804a-n toward a desired location and/or angle within an audio environment.

In some examples, the microphone array 802 may be a sound wave capture device (e.g., a 1.5D microphone array, a 2D linear and planar microphone array, a 3D surface arrays of microphones, and 3D suspended arrays of microphones) associated with omnidirectional and unidirectional audio capture devices. For instance, a 1.5D microphone array may be a microphone array configured to provide a one-dimensional form factor that has added directivity, for most, if not all, frequencies, in dimensions that, conventionally, have equal sensitivity in all directions.

The microphone array 802 may be configured to combine audio associated with respective beamforming lobes of the plurality of beamforming lobes 804a-n to generate the audio stream 106. In some examples, the audio stream may be configured based on a directional polar pattern associated with respective beamforming lobes of the plurality of beamforming lobes 804a-n.

In some examples, undesirable audio from an audio source may be out of direct beamforming coverage of a particular beamforming lobe of the microphone array 802 may still be captured by the microphone array 802 (e.g., by another beamforming lobe or as lower amplitude audio via the particular beamforming lobe) even though a particular beamforming lobe is dynamically re-directed away from the audio source. For instance, a beamforming lobe 804a and/or another beamforming lobe (e.g., beamforming lobe 804b or beamforming lobe 804n) may capture audio associated with an audio source 810a even though the plurality of beamforming lobes 804a-n is dynamically re-directed away from the audio source 810a. As such, the beamforming audio processing system 104 may apply selective beamforming muting to the audio stream 106 and/or the plurality of beamforming lobes 804a-n, as further disclosed herein.

The beamforming audio processing system 104 may further enable improved audio quality and intelligibility for audio output while selectively muting a certain number of the one or more audio sources 810a-n. By applying sophisticated signal processing techniques to generate and/or selectively mute the sound reinforcement audio, the beamforming audio processing system 104 further ensures that the remaining active audio sources are clearly captured and reproduced, even when portions of the audio environment are muted.

The term “machine learning model” refers to computational systems that implement machine learning or deep learning algorithms. The term “artificial intelligence” or “AI” refers broadly to computer systems designed to perform tasks that typically require human intelligence, including but not limited to reasoning, learning, problem-solving, perception, and natural language understanding. The term “machine learning” refers to a subset of artificial intelligence encompassing methods and algorithms that enable computer systems to learn patterns from data and make predictions or decisions without being explicitly programmed with rules for each specific scenario. Machine learning models are computer-implemented algorithms that may learn from data stored in databases or datastores, with or without relying on rules-based programming. These models enable reliable, repeatable decisions and results and facilitate the uncovering of hidden insights through machine-based learning from historical relationships and trends in the data.

Machine learning encompasses two primary learning paradigms: supervised learning and unsupervised learning. In supervised learning, a model is trained on a labeled dataset where each input example is paired with a corresponding target output or label. The model learns to map inputs to outputs by minimizing the difference between its predictions and the known labels. Examples of supervised learning tasks include classification (e.g., categorizing data into discrete classes such as spam detection, image recognition, or sentiment classification) and regression (e.g., predicting continuous values such as prices, temperatures, or durations).

Common supervised learning algorithms include linear regression, logistic regression, support vector machines (SVMs), decision trees, random forests, gradient boosting machines (e.g., XGBoost, LightGBM, CatBoost), k-nearest neighbors (KNN), and neural networks. In unsupervised learning, a model is trained on unlabeled data and must discover patterns, structures, or relationships within the data without explicit guidance. Examples of unsupervised learning tasks include clustering (e.g., grouping similar data points together using algorithms such as k-means, hierarchical clustering, DBSCAN, or Gaussian mixture models), dimensionality reduction (e.g., reducing the number of features while preserving important information using techniques such as principal component analysis (PCA), t-SNE, or UMAP), and anomaly detection (e.g., identifying unusual patterns or outliers in data). Semi-supervised learning combines elements of both paradigms, using a small amount of labeled data alongside a larger amount of unlabeled data to improve model performance.

A machine learning model is initially fit or trained on a training dataset comprising a set of examples used to fit or adjust the parameters of the model. During training, the model processes input data, generates predictions or outputs, and compares these outputs against target values (in supervised learning) or optimization objectives (in unsupervised learning). Based on the result of this comparison and the specific learning algorithm being used, the parameters of the model are adjusted through optimization techniques such as gradient descent, stochastic gradient descent (SGD), Adam, RMSprop, or other optimization algorithms.

Training data may be stored in databases or datastores and accessed via one or more application programming interfaces. The training process typically involves iterating over the training data multiple times (epochs) until the model converges to a satisfactory level of performance. Model performance is evaluated using metrics appropriate to the task, such as accuracy, precision, recall, F1 score, area under the ROC curve (AUC-ROC), mean squared error (MSE), mean absolute error (MAE), or other evaluation metrics. The machine learning models as described herein may make use of multiple ML engines (e.g., for analysis, transformation, inference, and other needs). The system may train different ML models for different needs and different ML-based engines, generate new models based on gathered training data, and evaluate their performance against existing models.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

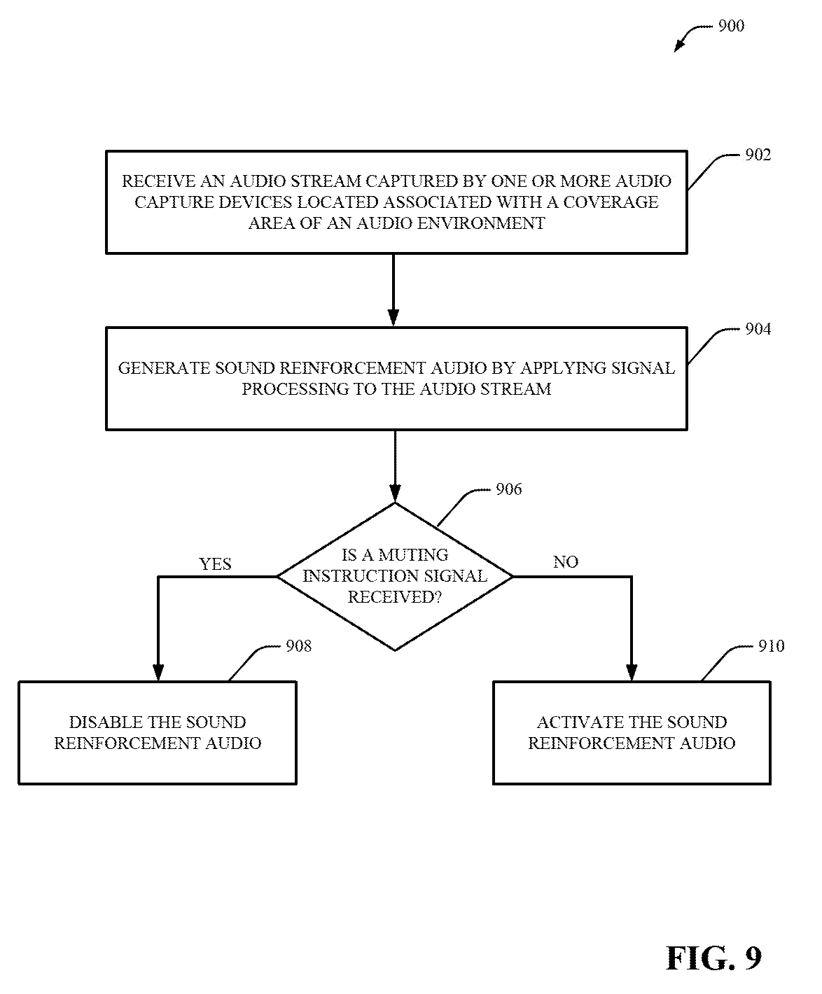

FIG. 9 is a flowchart diagram of an example process 900, for providing selective beamforming muting for an audio environment in accordance with, for example, the beamforming audio processing apparatus 202 illustrated in FIG. 2. Via the various blocks and/or operations of the process 900, the beamforming audio processing apparatus 202 may enhance quality, reliability, selective muting control, and/or privacy of beamformed audio data.

At block 902, a processor (e.g., the processor 204 and/or the sound reinforcement circuitry 208) receives an audio stream captured by one or more audio capture devices located associated with a coverage area of an audio environment. The audio environment may be an indoor environment, an outdoor environment, a room (e.g., a classroom, a courtroom, or another room in an indoor environment), a lecture hall, a performance hall, a broadcasting environment, a sports stadium or arena, a virtual environment, or another type of audio environment. In some examples, the one or more audio capture devices comprise a microphone array associated with a plurality of beamformed lobes for the coverage area.

At block 904, a processor (e.g., the processor 204 and/or the sound reinforcement circuitry 208) generates sound reinforcement audio by applying signal processing to the audio stream. The sound reinforcement audio may be an enhanced version of the audio stream to enable desirable and/or appropriately processed audio for a reinforcement area of the audio environment as compared to a coverage area of the audio environment associated with capture of audio for the audio stream. In some examples, the sound reinforcement audio includes beamformed audio data that is digitally processed to enhance audio of the audio stream for a particular reinforcement area.

At block 906, a processor (e.g., the processor 204 and/or the beamforming muting circuitry 210) determines whether a muting instruction is received. The muting instruction signal may include information for instructing a beamforming audio processing system to selectively mute or unmute a particular portion of the audio stream, one or more particular beamforming lobes of the one or more audio capture devices, and/or one or more particular areas within the audio environment. In some examples, the muting instruction signal may include information for instructing a beamforming audio processing system to selectively mute or unmute audio associated with a particular sound reinforcement audio channel associated with a coverage area of the audio environment. In some examples, the muting instruction signal comprises a coverage area identifier corresponding to the coverage area of the audio environment.

If yes, the process 900 proceeds to block 908. At block 908, a processor (e.g., the processor 204 and/or the beamforming muting circuitry 210) disables the sound reinforcement audio. For example, a processor (e.g., the processor 204 and/or the beamforming muting circuitry 210) may disable or discontinue a sound reinforcement audio channel between the coverage area and the reinforcement area to discontinue output of the sound reinforcement audio via one or more output devices. In some examples, muting may be selectively applied to the sound reinforcement audio channel to mute the sound reinforcement audio associated with the coverage area. If no, the process 900 proceeds to block 910. At block 910, a processor (e.g., the processor 204 and/or the sound reinforcement circuitry 208) activates the sound reinforcement audio. For example, a sound reinforcement audio channel between the coverage area and the reinforcement area may be enabled to output the sound reinforcement audio via one or more output devices.

Although the process 900 depicts a particular sequence of blocks and/or operations, the sequence may be altered without departing from the scope of the present disclosure. For example, some of the blocks and/or operations depicted may be performed in parallel or in a different sequence that does not materially affect the function of the processes. Additionally, such blocks and/or operations may be performed in any of a number of ways, including, without limitation, in the order and manner as depicted and described herein. In some examples, the process 900 includes some or all blocks and/or operations described and/or depicted. Similarly, it should be appreciated that one or more of the blocks and/or operations of the process 900 may be combinable, replaceable, and/or otherwise altered as described herein.

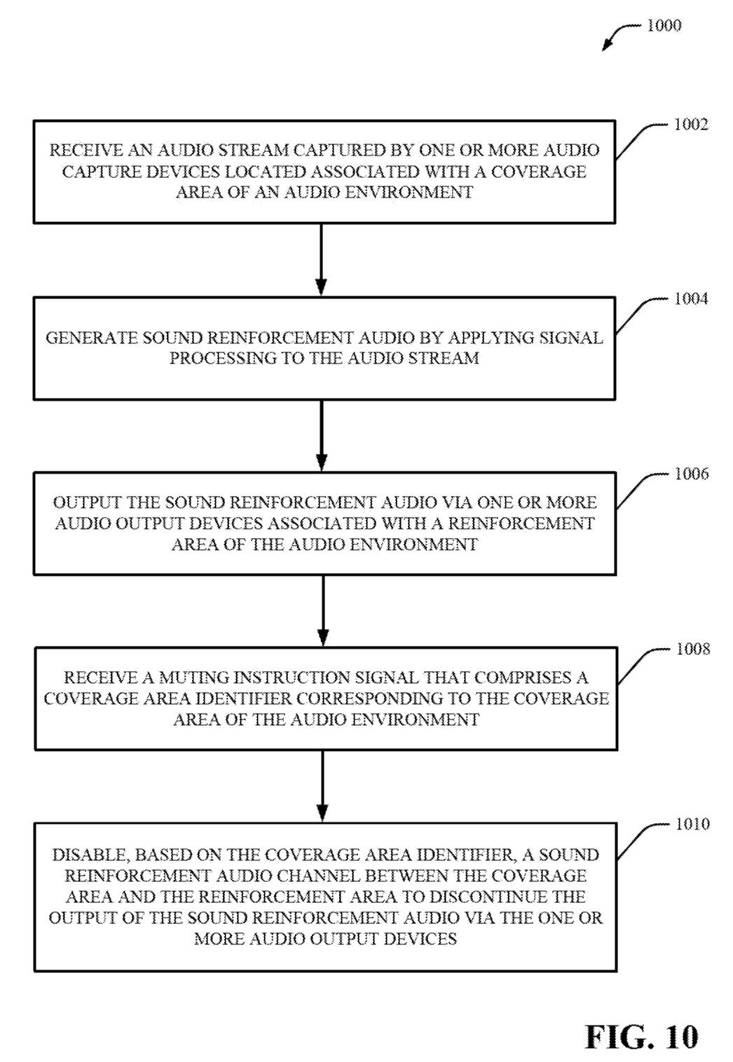

FIG. 10 is a flowchart diagram of an example process 1000, for providing selective beamforming muting for an audio environment in accordance with, for example, the beamforming audio processing apparatus 202 illustrated in FIG. 2. Via the various blocks and/or operations of the process 1000, the beamforming audio processing apparatus 202 may enhance quality, reliability, selective muting control, and/or privacy of beamformed audio data.

At block 1002, a processor (e.g., the processor 204 and/or the sound reinforcement circuitry 208) receives an audio stream captured by one or more audio capture devices located associated with a coverage area of an audio environment. The audio environment may be an indoor environment, an outdoor environment, a room (e.g., a classroom, a courtroom, or another room in an indoor environment), a lecture hall, a performance hall, a broadcasting environment, a sports stadium or arena, a virtual environment, or another type of audio environment. In some examples, the one or more audio capture devices comprise a microphone array associated with a plurality of beamformed lobes for the coverage area. In some examples, a processor (e.g., the processor 204 and/or the sound reinforcement circuitry 208) receives the audio stream from a dedicated beamforming lobe associated with an undesirable audio location within the audio environment. The undesirable audio location may refer to a location within the audio environment where audio capture is not desired for transmission to a reinforcement area or a far-end of an audio or video call. For example, an undesirable audio location may include a doorway or other location where undesired talking by a speaker entity may occur.

At block 1004, a processor (e.g., the processor 204 and/or sound reinforcement circuitry 208) generates sound reinforcement audio by applying signal processing to the audio stream. The sound reinforcement audio may be an enhanced version of the audio stream to enable desirable and/or appropriately processed audio for a reinforcement area of the audio environment as compared to a coverage area of the audio environment associated with capture of audio for the audio stream. In some examples, the sound reinforcement audio includes beamformed audio data that is digitally processed to enhance audio of the audio stream for a particular reinforcement area.

At block 1006, a processor (e.g., the processor 204 and/or the sound reinforcement circuitry 208) outputs the sound reinforcement audio via one or more audio output devices associated with a reinforcement area of the audio environment. For example, a processor (e.g., the processor 204 and/or the beamforming muting circuitry 210) may enable a sound reinforcement audio channel between the coverage area and the reinforcement area to output the sound reinforcement audio via the one or more audio output devices.

At block 1008, a processor (e.g., the processor 204 and/or the beamforming muting circuitry 210) receives a muting instruction signal that comprises a coverage area identifier corresponding to the coverage area of the audio environment. In some examples, a processor (e.g., the processor 204 and/or the beamforming muting circuitry 210) generates the muting instruction signal in response to activation of a physical button of a device. In some examples, the muting instruction signal is received based on a user interface action associated activation of an interactive element of a user interface and/or an application programming interface action associated with transmission of the muting instruction signal via a communication channel. In some examples, a processor (e.g., the processor 204 and/or the beamforming muting circuitry 210) generates the muting instruction signal in response to activation of an interactive element of a user interface. In some examples, a processor (e.g., the processor 204 and/or the beamforming muting circuitry 210) receives the muting instruction signal via a communication channel associated with an application programming interface.

In some examples, a processor (e.g., the processor 204 and/or the beamforming muting circuitry 210) applies one or more speech recognition techniques to the audio stream to identify a predefined word or phrase associated with the audio stream. Additionally, a processor (e.g., the processor 204 and/or the beamforming muting circuitry 210) generates the muting instruction signal responsive to the predefined word or phrase.

In some examples, a processor (e.g., the processor 204 and/or the beamforming muting circuitry 210) receives a video stream that comprises the audio stream captured by the one or more audio capture devices. In some examples, a processor (e.g., the processor 204 and/or the beamforming muting circuitry 210) applies one or more gesture recognition techniques to the video stream to identify a predefined gesture associated with the video stream. Additionally, a processor (e.g., the processor 204 and/or the beamforming muting circuitry 210) generates the muting instruction signal responsive to the predefined gesture.

At block 1010, a processor (e.g., the processor 204 and/or the beamforming muting circuitry 210) disables a sound reinforcement audio channel between the coverage area and the reinforcement area based the coverage area identifier to discontinue the output of the sound reinforcement audio via the one or more audio output devices. In some examples, a processor (e.g., the processor 204 and/or the beamforming muting circuitry 210) transmits the muting instruction signal to respective audio capture devices within the coverage area to cause the audio capture device to mute audio capture via the audio capture device. For instance, a processor (e.g., the processor 204 and/or the beamforming muting circuitry 210) may transmit the muting instruction signal to an audio capture device of the one or more audio captures devices that is located within the coverage area.

In some examples, a processor (e.g., the processor 204 and/or the beamforming muting circuitry 210) identifies an audio source associated with a speaker entity within the coverage area. Additionally, a processor (e.g., the processor 204 and/or the beamforming muting circuitry 210) disables a beamforming lobe associated with the audio source based on the muting instruction signal.

In some examples, a processor (e.g., the processor 204 and/or the beamforming muting circuitry 210) identifies an audio source associated with a speaker entity within the coverage area. In some examples, a processor (e.g., the processor 204 and/or the beamforming muting circuitry 210) identifies two or more beamforming lobes associated with the audio source based on the audio stream. Additionally, a processor (e.g., the processor 204 and/or the beamforming muting circuitry 210) disables the two or more beamforming lobes associated with the audio source based on the muting instruction signal.

In some examples, a processor (e.g., the processor 204 and/or the beamforming muting circuitry 210) identifies a position of an audio source associated with a speaker entity within the coverage area. Additionally, a processor (e.g., the processor 204 and/or the beamforming muting circuitry 210) disables a beamforming lobe associated with the audio source based on the muting instruction signal and the position of the audio source within the coverage area.

In some examples, the one or more audio output devices are one or more first audio output devices and, responsive to the muting instruction signal, a processor (e.g., the processor 204 and/or the beamforming muting circuitry 210) disables the sound reinforcement audio channel between the coverage area and the reinforcement area. Additionally, responsive to the muting instruction signal, a processor (e.g., the processor 204 and/or the beamforming muting circuitry 210) outputs predefined audio via one or more second audio output devices associated with the coverage area.

Although the process 1000 depicts a particular sequence of blocks and/or operations, the sequence may be altered without departing from the scope of the present disclosure. For example, some of the blocks and/or operations depicted may be performed in parallel or in a different sequence that does not materially affect the function of the processes. Additionally, such blocks and/or operations may be performed in any of a number of ways, including, without limitation, in the order and manner as depicted and described herein. In some examples, the process 1000 includes some or all blocks and/or operations described and/or depicted. Similarly, it should be appreciated that one or more of the blocks and/or operations of the process 1000 may be combinable, replaceable, and/or otherwise altered as described herein.

Although example processing systems have been described in the figures herein, implementations of the subject matter and the functional operations described herein may be implemented in other types of digital electronic circuitry, or in computer software, or hardware, including the structures disclosed in this specification and their structural equivalents, or in combinations of one or more of them.

Embodiments of the subject matter and the operations described herein may be implemented in digital electronic circuitry, or in computer software, or hardware, including the structures disclosed in this specification and their structural equivalents, or in combinations of one or more of them. Embodiments of the subject matter described herein may be implemented as one or more computer programs, e.g., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term "or" is used herein in both the alternative and conjunctive sense, unless otherwise indicated. The terms "illustrative," "example," and "exemplary" are used to be examples with no indication of quality level. Like numbers refer to like elements throughout.

The term "comprising" means "including but not limited to," and should be interpreted in the manner it is typically used in the patent context. Use of broader terms such as comprises, includes, and having should be understood to provide support for narrower terms, such as consisting of, consisting essentially of, comprised substantially of, and/or the like.

The phrases "in one embodiment," "according to one embodiment," and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to receive an audio stream captured by one or more audio capture devices associated with a coverage area of an audio environment.

Clause 2. The apparatus of clause 1, wherein the instructions are further operable to cause the apparatus to generate sound reinforcement audio by applying signal processing to the audio stream.

Clause 3. The apparatus of any one of the foregoing clauses, wherein the instructions are further operable to cause the apparatus to output the sound reinforcement audio via one or more audio output devices associated with a reinforcement area of the audio environment.

Clause 4. The apparatus of any one of the foregoing clauses, wherein the instructions are further operable to cause the apparatus to receive a muting instruction signal associated with a coverage area identifier corresponding to the coverage area of the audio environment.

Clause 5. The apparatus of any one of the foregoing clauses, wherein the instructions are further operable to cause the apparatus to disable, based on the coverage area identifier, a sound reinforcement audio channel between the coverage area and the reinforcement area to discontinue the output of the sound reinforcement audio via the one or more audio output devices.

Clause 6. The apparatus of any one of the foregoing clauses, wherein the instructions are further operable to cause the apparatus to generate the muting instruction signal in response to activation of a physical button of a device.

Clause 7. The apparatus of any one of the foregoing clauses, wherein the instructions are further operable to cause the apparatus to receive the muting instruction signal based on an action selected from the group consisting of a user interface action associated activation of an interactive element of a user interface and an application programming interface action associated with transmission of the muting instruction signal via a communication channel.

Clause 8. The apparatus of any one of the foregoing clauses, wherein the instructions are further operable to cause the apparatus to receive the muting instruction signal via a communication channel associated with an application programming interface.

Clause 9. The apparatus of any one of the foregoing clauses, wherein the instructions are further operable to cause the apparatus to apply one or more speech recognition techniques to the audio stream to identify a predefined word or phrase associated with the audio stream.

Clause 10. The apparatus of any one of the foregoing clauses, wherein the instructions are further operable to cause the apparatus to generate the muting instruction signal responsive to the predefined word or phrase.

Clause 11. The apparatus of any one of the foregoing clauses, wherein the instructions are further operable to cause the apparatus to receive a video stream that comprises the audio stream captured by the one or more audio capture devices.

Clause 12. The apparatus of any one of the foregoing clauses, wherein the instructions are further operable to cause the apparatus to apply one or more gesture recognition techniques to the video stream to identify a predefined gesture associated with the video stream.

Clause 13. The apparatus of any one of the foregoing clauses, wherein the instructions are further operable to cause the apparatus to generate the muting instruction signal responsive to the predefined gesture.

Clause 14. The apparatus of any one of the foregoing clauses, wherein the one or more audio capture devices correspond to beamforming lobes of a microphone array.

Clause 15. The apparatus of any one of the foregoing clauses, wherein the instructions are further operable to cause the apparatus to receive the audio stream from a dedicated beamforming lobe associated with an undesirable audio location within the audio environment.

Clause 16. The apparatus of any one of the foregoing clauses, wherein the instructions are further operable to cause the apparatus to transmit the muting instruction signal to an audio capture device of the one or more audio captures devices that is located within the coverage area to cause the audio capture device to mute audio capture via the audio capture device.

Clause 17. The apparatus of any one of the foregoing clauses, wherein the instructions are further operable to cause the apparatus to identify an audio source associated with a speaker entity within the coverage area.

Clause 18. The apparatus of any one of the foregoing clauses, wherein the instructions are further operable to cause the apparatus to disable a beamforming lobe associated with the audio source based on the muting instruction signal.

Clause 19. A computer-implemented method comprising steps in accordance with any one of the foregoing clauses.

Clause 20. A computer program product, stored on a computer readable medium, comprises instructions that, when executed by one or more processors of the audio signal processing apparatus, cause the one or more processors to perform one or more operations related to any one of the foregoing clauses.

Clause 21. A system comprising an audio capture device and an audio output device.

Clause 22. The system of clause 21, the audio capture device configured to capture an audio stream associated with a coverage area of an audio environment.

Clause 23. The system of any one of the foregoing clauses 21-22, the audio output device configured to (i) output sound reinforcement audio associated with a processed version of the audio stream via a reinforcement area of the audio environment and (ii) disable output of the sound reinforcement audio based on a muting instruction signal associated with a coverage area identifier corresponding to the coverage area of the audio environment.

Clause 24. The system of any one of the foregoing clauses 21-23, wherein the instructions are further operable to cause the apparatus to disable a beamforming lobe associated with the audio source based on the muting instruction signal.

Clause 25. A computer-implemented method comprising steps in accordance with any one of the foregoing clauses 21-24.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the at least one processor, to cause the apparatus to:
receive an audio stream captured by one or more audio capture devices associated with a coverage area of an audio environment;
generate sound reinforcement audio by applying signal processing to the audio stream;
output the sound reinforcement audio via one or more audio output devices associated with a reinforcement area of the audio environment;
receive a muting instruction signal associated with a coverage area identifier corresponding to the coverage area of the audio environment; and
disable, based on the coverage area identifier, a sound reinforcement audio channel between the coverage area and the reinforcement area to discontinue the output of the sound reinforcement audio via the one or more audio output devices.

2. The apparatus of claim 1, wherein the instructions are further operable to cause the apparatus to:
generate the muting instruction signal in response to activation of a physical button of a device.

3. The apparatus of claim 1, wherein the instructions are further operable to cause the apparatus to:
receive the muting instruction signal based on an action selected from the group consisting of a user interface action associated activation of an interactive element of a user interface and an application programming interface action associated with transmission of the muting instruction signal via a communication channel.

4. The apparatus of claim 1, wherein the instructions are further operable to cause the apparatus to:
apply one or more speech recognition techniques to the audio stream to identify a predefined word or phrase associated with the audio stream; and
generate the muting instruction signal responsive to the predefined word or phrase.

5. The apparatus of claim 1, wherein the instructions are further operable to cause the apparatus to:
receive a video stream that comprises the audio stream captured by the one or more audio capture devices;
apply one or more gesture recognition techniques to the video stream to identify a predefined gesture associated with the video stream; and
generate the muting instruction signal responsive to the predefined gesture.

6. The apparatus of claim 1, wherein the one or more audio capture devices correspond to beamforming lobes of a microphone array.

7. The apparatus of claim 1, wherein the instructions are further operable to cause the apparatus to:
receive the audio stream from a dedicated beamforming lobe associated with an undesirable audio location within the audio environment.

8. The apparatus of claim 1, wherein the instructions are further operable to cause the apparatus to:
transmit the muting instruction signal to an audio capture device of the one or more audio captures devices that is located within the coverage area to cause the audio capture device to mute audio capture via the audio capture device.

9. The apparatus of claim 1, wherein the instructions are further operable to cause the apparatus to:
identify an audio source associated with a speaker entity within the coverage area; and
disable a beamforming lobe associated with the audio source based on the muting instruction signal.

10. The apparatus of claim 1, wherein the instructions are further operable to cause the apparatus to:
identify an audio source associated with a speaker entity within the coverage area;
identify two or more beamforming lobes associated with the audio source based on the audio stream; and
disable the two or more beamforming lobes associated with the audio source based on the muting instruction signal.

11. The apparatus of claim 1, wherein the instructions are further operable to cause the apparatus to:
identify a position of an audio source associated with a speaker entity within the coverage area; and
disable a beamforming lobe associated with the audio source based on the muting instruction signal and the position of the audio source within the coverage area.

12. The apparatus of claim 1, wherein the one or more audio output devices are one or more first audio output devices, and wherein the instructions are further operable to cause the apparatus to:
responsive to the muting instruction signal,
disable the sound reinforcement audio channel between the coverage area and the reinforcement area; and
output predefined audio via one or more second audio output devices associated with the coverage area.

13. A computer-implemented method comprising:
receiving an audio stream captured by one or more audio capture devices associated with a coverage area of an audio environment;
generating sound reinforcement audio by applying signal processing to the audio stream;
outputting the sound reinforcement audio via one or more audio output devices associated with a reinforcement area of the audio environment;
receiving a muting instruction signal associated with a coverage area identifier corresponding to the coverage area of the audio environment; and
disabling, based on the coverage area identifier, a sound reinforcement audio channel between the coverage area and the reinforcement area to discontinue the output of the sound reinforcement audio via the one or more audio output devices.

14. The computer-implemented method of claim 13, further comprising:
generating the muting instruction signal in response to activation of a physical button of a device.

15. The computer-implemented method of claim 13, wherein receiving the muting instruction signal comprises receiving the muting instruction signal based on an action selected from the group consisting of a user interface action associated activation of an interactive element of a user interface and an application programming interface action associated with transmission of the muting instruction signal via a communication channel.

16. The computer-implemented method of claim 13, further comprising:
applying one or more speech recognition techniques to the audio stream to identify a predefined word or phrase associated with the audio stream; and
generating the muting instruction signal responsive to the predefined word or phrase.

17. The computer-implemented method of claim 13, further comprising:
receiving a video stream that comprises the audio stream captured by the one or more audio capture devices;
applying one or more gesture recognition techniques to the video stream to identify a predefined gesture associated with the video stream; and
generating the muting instruction signal responsive to the predefined gesture.

18. The computer-implemented method of claim 13, wherein receiving the audio stream comprises receiving the audio stream from a dedicated beamforming lobe associated with an undesirable audio location within the audio environment.

19. The computer-implemented method of claim 13, further comprising:
transmitting the muting instruction signal to an audio capture device of the one or more audio captures devices that is located within the coverage area to cause the audio capture device to mute audio capture via the audio capture device.

20. A system, comprising:
an audio capture device configured to capture an audio stream associated with a coverage area of an audio environment; and
an audio output device configured to (i) output sound reinforcement audio associated with a processed version of the audio stream via a reinforcement area of the audio environment and (ii) disable output of the sound reinforcement audio based on a muting instruction signal associated with a coverage area identifier corresponding to the coverage area of the audio environment.
